(19) United States
(12) Patent Application Publication
(10) Pub. No.: US 2012/0170683 A1
(43) Pub. Date: Jul. 5, 2012

(54) Methods, Apparatuses, and Related Computer Program Product for Information Channel Configuration

(76) Inventors: Frank Frederiksen, Klarup (DK); Esa Tapani Tiirola, Kempele (FI); Kari Pekka Pajukoski, Oulu (FI); Kari Juhani Hooli, Oulu (FI)

(21) Appl. No.: 13/379,496

(22) PCT Filed: Jun. 23, 2009
(86) PCT No.: PCT/EP2009/057835

§ 371 Date: Mar. 20, 2012

(51) Int. Cl. H04L 27/20

(52) U.S. Cl. 375/308

(57) ABSTRACT

It is disclosed a method (and related apparatus) including configuring N information channels each carrying acknowledgement information such that the N pieces of acknowledgement information are transmittable in the form of a phase shift keying symbol having an order of N², N being an integer equal to or greater than 2; and a method (and related apparatus) including configuring N information channels each carrying acknowledgement information such that the N pieces of acknowledgement information are receivable in the form of the phase shift keying symbol having the order of N².

### FIELD OF THE INVENTION

Examples of the present invention relate to information channel configuration. More specifically, the examples of the present invention relate to methods, apparatuses, and a related computer program product for information channel configuration. The examples of the present invention may be applicable e.g. to the concept creation and standardisation efforts for continuation of the long term evolution (LTE) of 3^{rd} generation partnership project (3GPP) and/or to a control channel structure in the context of frequency division duplex (FDD) or time division duplex (TDD).

### BACKGROUND

One of the features of LTE is usage of fast hybrid automatic repeat request (H-ARQ), which may be used to increase the spectral efficiency. H-ARQ operation for dynamic scheduled uplink data may function such that that there may be, for each uplink resource grant (signaled e.g. on the physical downlink control channel (PDCCH)), an associated H-ARQ feedback channel for positive and negative acknowledgements (ACK/NACK or A/N). However, there may be a delay between the time of the uplink grant (on the PDCCH) and the time where the user equipment (UE) may actually transmit uplink data, and further the time where the evolved node B (eNB or eNode B) may send the ACK/NACK on the PHICH (physical H-ARQ indication channel). It may be assumed that the scheduling delay will be 3 ms (plus the delay of the actual signaling on the PDCCH), and that the eNode B processing time will also be 3 ms. This means that the timing relation for a single H-ARQ process or channel may be (TTI means transmission time interval):
TTI190 0: uplink (UL) allocation grant on the PDCCH;
TTI#4: UL data transmission; and
TTI#8: ACK/NACK on the PHICH or a dynamic scheduling (e.g. on the PDCCH) e.g. for non-adaptive H-ARQ.

Related to the H-ARQ operation, a reception status may be notified to the UE that originally transmitted the data packet to the e-Node B. For example, the PHICH may be transmitted on a resource given through the following equations, which identify which PHICH group and which PHICH index the UE should monitor for the HARQ indication. These equations may identify the PHICH resource e.g. by an index pair (n_{PHICH} ^{group}, n_{PHICH}^{seq}):

n_{PHICH}^{group}=(I_{PRB}_{_{—}}RA^{lowest} ^{_{—}}^{indexs}+n_{DMRS)mod} N_{PHICH}^{group}+I_{PHICH}N_{PHICH}^{group,}

n_{PHICH}^{seq}32 (└I_{PRB}_{_{—}}_{RA}^{lowest}^{_{—}}^{index}/N_{PHICH}^{group}┘+n_{DMRS})mod 2N_{SF}^{PHICH}

where N_{PHICH}^{group} is the PHICH group number, n_{PHICH}^{seq} is the orthogonal sequence index within the group and └ ┘ is the next lower integer operator.

As derivable from the above equations, the actual used PHICH group and index may be derived from the lowest physical resource block (PRB) index of the uplink resource allocation/grant combined with the index of the cyclic shift of the demodulation reference sequence (DMRS).

Moreover, there has been an approach related to configuration of uplink single user (SU) spatial multiplexing transmission with or without the layer shifting. In the case with layer shifting spatial bundling of HARQ parameters may be applied. This would mean that logical AND operation is applied for HARQ-ACK feedback signaling corresponding to multiple transport blocks. Correspondingly, only one HARQ-ACK feedback signal needs to be transmitted on PHICH. However, if layer shifting is not configured, each transport block has its own HARQ-ACK feedback signaling.

In consideration of the above, according to examples of the present invention, methods, apparatuses and a related computer program product for information channel configuration are provided.

In this connection, the examples of the present invention enable one or more of the following:
Providing a solution for the situation where SU MIMO (multiple-input-multiple-output) (e.g. spatial multiplexing) is introduced;
Enabling operation of SU MIMO (spatial multiplexing) without layer shifting (i.e. transmission of ACK/NACK (A/N) information for each of two transport blocks), in which two PHICH channels are assigned to the UE;
Avoiding introducing a linear mapping between the DMRS resources used for each layer (each layer may use a different DMRS to have orthogonal reference symbols) and the PHICH channel used, thus avoiding non-optimum mapping to PHICH channels;
Enabling optimized PHICH performance, i.e. power balancing and orthogonality;
Enabling optimized PHICH arrangement;
Enabling optimized cyclic shift separation e.g. between four transmitting antennas;
Enabling optimized PHICH performance with dual-bit ACK/NACK, i.e. supporting multi user MIMO (MU MIMO) pairing with optimized cyclic shift properties and dispensing with a need to signal DMRS resource dynamically in an UL grant.

### BRIEF DESCRIPTION OF THE DRAWINGS

The examples of the present invention are described herein below with reference to the accompanying drawings, in which:

FIG. 1 shows methods for information channel configuration according to a first and a second example of the present invention;

FIG. 2 shows apparatuses for information channel configuration according to the first and second examples of the present invention;

FIG. 3 shows the first example of the present invention in greater detail; and

FIG. 4 shows the second example of the present invention in greater detail.

### DETAILED DESCRIPTION OF THE EXAMPLES OF THE PRESENT INVENTION

The examples of the present invention are described herein below by way of example with reference to the accompanying drawings.

It is to be noted that for this description, the terms “physical hybrid automatic repeat request indicator channels (e.g. having no layer shifting); acknowledgement/non-acknowledgement signal; cyclic shift fields in a downlink control information format; evolved node B and UE” are examples for “information channels; acknowledgement information; cyclic shift information; and apparatus”, respectively, without restricting the latter-named terms to the special technical or implementation details imposed to the first-named terms.

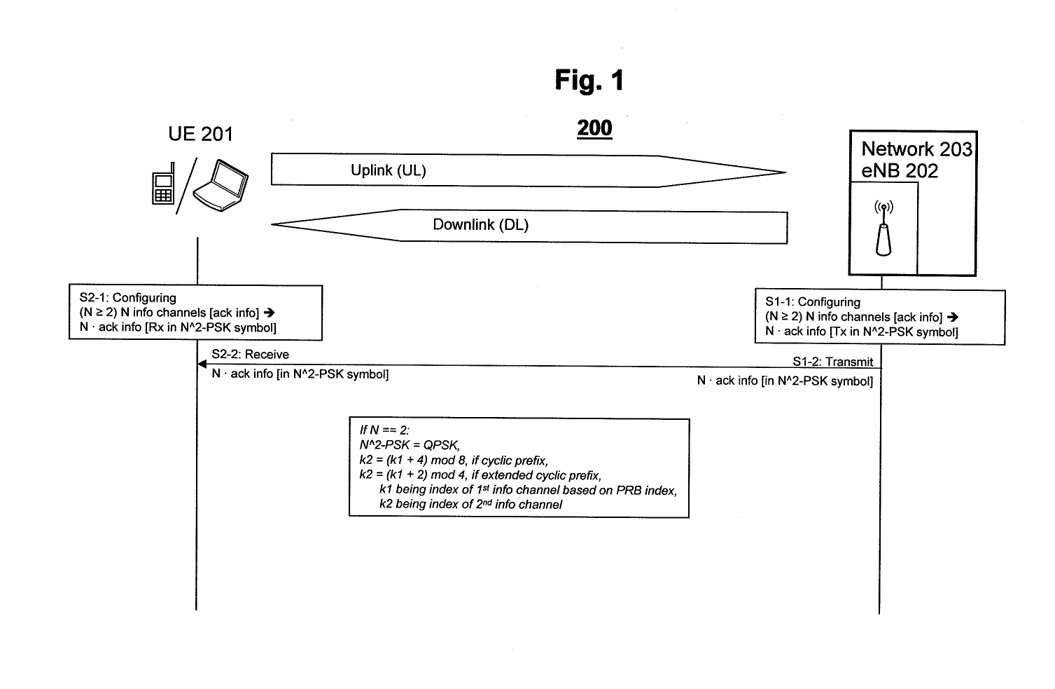

FIG. 1 shows the methods for information channel configuration according to the first and second examples of the present invention. Signaling between elements is indicated in horizontal direction, while time aspects between signaling may be reflected in the vertical arrangement of the signaling sequence as well as in the sequence numbers. It is to be noted that the time aspects indicated in FIG. 1 do not necessarily restrict any one of the method steps shown to the step sequence outlined. This applies in particular to method steps that are functionally disjunctive with each other, for example configuring in steps S1-1 and S2-1. Within FIG. 1, for ease of description, means or portions which may provide main functionalities are depicted with solid functional blocks or arrows and/or a normal font, while means or portions which may provide optional functions are depicted with dashed functional blocks or arrows and/or an italic font.

As shown in FIG. 1, a communication system 200 may comprise a UE 201 and a network 203. In turn, the network 203 may further comprise an eNB 202.

As shown in FIG. 1, in step S1-1, e.g. the eNB 202 may perform configuring N information channels (e.g. PHICHs in case of no layer shifting) each carrying acknowledgement information (e.g. A/N signal) such that the N pieces of acknowledgement information are transmittable in the form of a phase shift keying symbol having an order of N² (e.g. QPSK symbol or higher-order PSK symbol), N being an integer equal to or greater than 2.

Further, in step S2-1, e.g. the UE 201 may perform configuring the N information channels (e.g. PHICHs in case of no layer shifting) each carrying the acknowledgement information (e.g. A/N signal) such that the N pieces of acknowledgement information are receivable in the form of a phase shift keying symbol having the order of N² (at least QPSK symbol).

Then, in step S1-2, e.g. the eNB 202 may perform transmitting, on the N information channels, the N pieces of acknowledgement information in the form of the phase shift keying symbol having the order of N². Thus, in step S2-2, e.g. the UE 201 may perform receiving, on the N information channels, the N pieces of acknowledgement information in the form of the phase shift keying symbol having the order of N².

As developments of the methods pertaining to the UE 201 and the eNB 202, each of the N information channels may be associated with a respective one of N transport blocks.

As a particular example related to the first and second examples, N may equal to 2, and the phase shift keying symbol may be a quadrature phase shift keying symbol. If so, in case of usage of a cyclic prefix, the first information channel may be assigned a first index k1 based on a physical resource block index, and the second information channel may be assigned a second index k2 according to k2=(k1+4) mod 8. Alternatively, in case of usage of an extended cyclic prefix, the first information channel may be assigned a first index k1 based on a physical resource block index, and the second information channel may be assigned a second index k2 according to k2=(k1+2) mod 4.

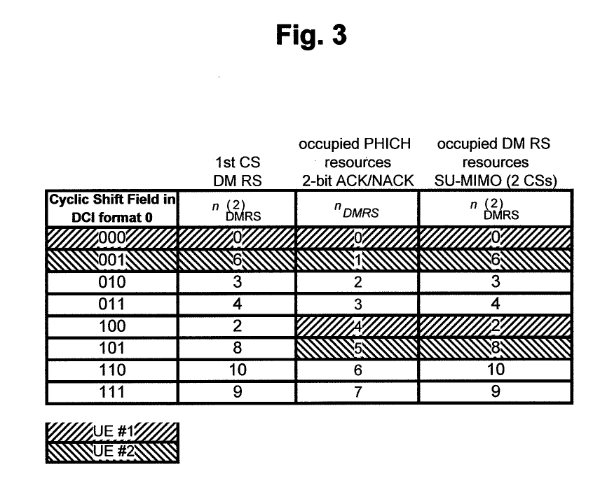

In both of the above alternatives, as shown in FIG. 3, in case of an initial cyclic prefix length valid for both initial cyclic prefix and extended cyclic prefix, the first and second information channels may be associated with cyclic shift resources. Further, the first and second indices may respectively correspond to cyclic shift information (e.g. cyclic shift fields in downlink control information (DCI) format) associated with the first and second information channels.

As shown in FIG. 3, in case of an initial cyclic prefix length, e.g. a first UE may be assigned a cyclic shift value of “000”. Accordingly, the first index k1 may be “0”, and the second index may be “4” (i.e. (0+4) mod 8). Further, a second UE may be assigned a cyclic shift value of “001”. Thus, the first index k1 may be “1”, and the second index may be “5” (i.e. (1+4) mod 8) e.g. within the same PHICH group. Alternatively, in case of an extended cyclic prefix length, a first UE may be assigned a cyclic shift value of “000”. Accordingly, the first index k1 may be “0”, and the second index may be “2” (i.e. (0+2) mod 4) e.g. within the same PHICH group. A second UE may be assigned a cyclic shift value of “001”. Thus, the first index k1 may be “1”, and the second index may be “3” (i.e. (1+2) mod 4).

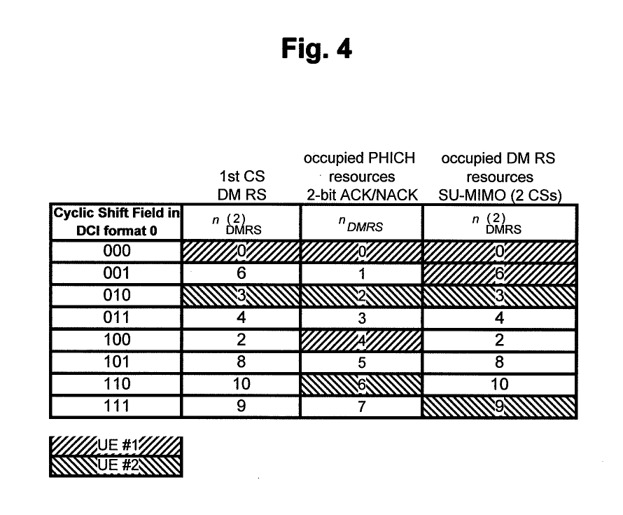

Further, in both of the above alternatives (i.e. cyclic shift or extended cyclic shift), as shown in FIG. 4, the first and second information channels may be decoupled from cyclic shift resources.

Thus, as shown in FIG. 4, in case of an initial cyclic prefix length, a first UE may be assigned a first index k1 being “0” independently from the cyclic shift value, and the second index may be “4” (i.e. (0+4) mod 8). Further, a second UE may be assigned a first index k1 being “6” independently from the cyclic shift value, and the second index may be “2” (i.e. (6+4) mod 8) e.g. in the same PHICH group. Alternatively, in case of an extended cyclic prefix length, a first UE may be assigned a first index k1 being “0”, and the second index may be “2” (i.e. (0+2) mod 4) e.g. within the same PHICH group. A second UE may be assigned a first index k1 being “3”, and the second index may be “1” (i.e. (3+2) mod 4) e.g. in the same PHICH group.

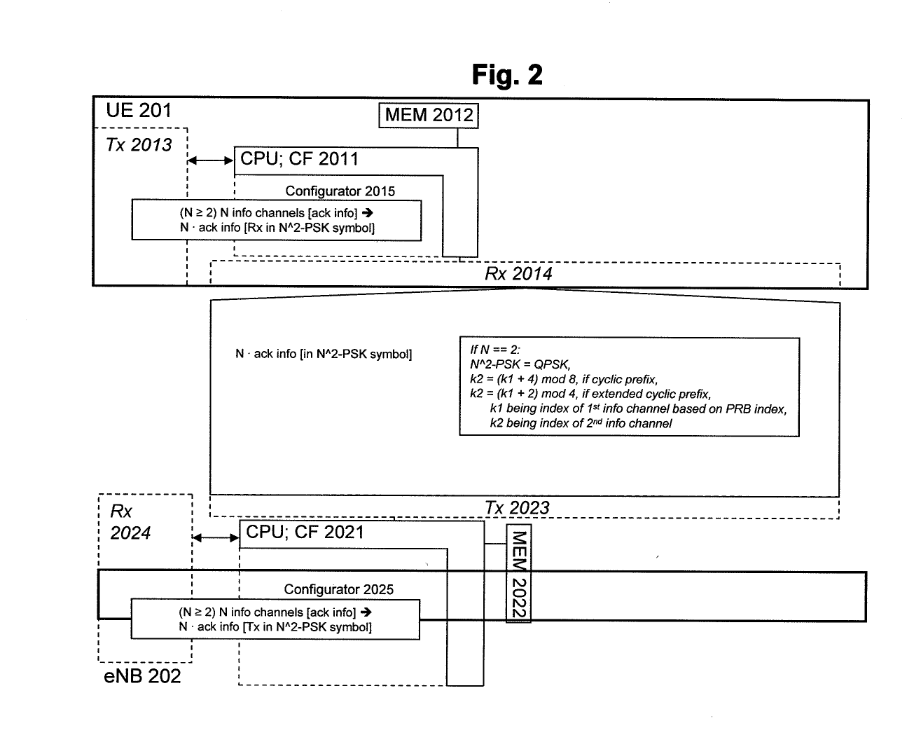

FIG. 2 shows apparatuses (e.g. UE 201 and eNB 202) for information channel configuration according to the first and second examples of the present invention. Within FIG. 2, for ease of description, means or portions which may provide main functionalities are depicted with solid functional blocks or arrows and/or a normal font, while means or portions which may provide optional functions are depicted with dashed functional blocks or arrows and/or an italic font.

UE 201 may comprise a CPU (or core functionality CF) 2011, a memory 2012, an optional transmitter (or means for transmitting) 2013, an optional receiver (or means for receiving) 2014, and a configurator (or means for configuring) 2015.

The eNB 202 may comprise a CPU (or core functionality CF) 2021, a memory 2022, an optional transmitter (or means for transmitting) 2023, an optional receiver (or means for receiving) 2024, and a configurator (or means for configuring) 2025.

As indicated by the dashed extensions of the functional blocks of the CPU 2011 or 2021, the means for configuring 2015 of the UE 201 as well as the means for configuring 2025 of the eNB 202 may be functionalities running on the CPU 2011 or 2021 of the UE 201 and/or eNB 202, or may alternatively be separate functional entities or means.

The CPUs 20x1 (wherein x=1 and/or 2) may respectively be configured, for example by software residing in the memory 20x2, to process various data inputs and to control the functions of the memories 20x2, the means for transmitting 202x3 and the means for receiving 20x4 (and the means for configuring 2015 of the UE 201 as well as the means for configuring 2025 of the eNB 202). The memories 20x2 may serve e.g. for storing code means for carrying out e.g. the methods according to the example of the present invention, when run e.g. on the CPUs 20x1. It is to be noted that the means for transmitting 20x3 and the means for receiving 20x4 may alternatively be provided as respective integral transceivers. It is further to be noted that the transmitters/receivers may be implemented i) as physical transmitters/receivers for transceiving e.g. via the air interface (e.g. between the UE 201 and the eNB 202), ii) as routing entities e.g. for transmitting/receiving data packets e.g. in a PS (packet switching) network (e.g. between the eNB 202 and another network element (not shown) when disposed as separate network entities), iii) as functionalities for writing/reading information into/from a given memory area (e.g. in case of shared/common CPUs or memories e.g. of the eNB 202 and another network element (not shown) when disposed as an integral network entity), or iv) as any suitable combination of i) to iii).

As shown in FIG. 2, e.g. the means for configuring 2025 of the eNB 202 may perform configuring N information channels (e.g. PHICHs in case of no layer shifting) each carrying acknowledgement information (e.g. A/N signal) such that the N pieces of acknowledgement information are transmittable in the form of a phase shift keying symbol having an order of N² (e.g. QPSK symbol or higher-order PSK symbol), N being an integer equal to or greater than 2.

Further, e.g. the means for configuring 2015 of the UE 201 may perform configuring the N information channels (e.g. PHICHs in case of no layer shifting) each carrying the acknowledgement information (e.g. A/N signal) such that the N pieces of acknowledgement information are receivable in the form of a phase shift keying symbol having the order of N² (at least QPSK symbol).

Then, e.g. the means for transmitting 2023 of the eNB 202 may perform transmitting, on the N information channels, the N pieces of acknowledgement information in the form of the phase shift keying symbol having the order of N². Thus, e.g. the means for receiving 2014 of the UE 201 may perform receiving, on the N information channels, the N pieces of acknowledgement information in the form of the phase shift keying symbol having the order of N².

As developments of the UE 201 and the eNB 202, each of the N information channels may be associated with a respective one of N transport blocks.

As a particular example related to the first and second examples, N may equal to 2, and the phase shift keying symbol may be a quadrature phase shift keying symbol. If so, in case of usage of a cyclic prefix, the first information channel may be assigned a first index k1 based on a physical resource block index, and the second information channel may be assigned a second index k2 according to k2=(k1+4) mod 8. Alternatively, in case of usage of an extended cyclic prefix, the first information channel may be assigned a first index k1 based on a physical resource block index, and the second information channel may be assigned a second index k2 according to k2=(k1+2) mod 4.

In both of the above alternatives (i.e. a cyclic prefix and extended cyclic prefix), as shown in FIG. 3, in case of an initial cyclic prefix length valid for both initial cyclic prefix and extended cyclic prefix, the first and second information channels may be associated with cyclic shift resources. Further, the first and second indices may respectively correspond to cyclic shift information (e.g. cyclic shift fields in downlink control information (DCI) format) associated with the first and second information channels.

As shown in FIG. 3, in case of an initial cyclic prefix length, e.g. a first UE may be assigned a cyclic shift value of “000”. Accordingly, the first index k1 may be “0”, and the second index may be “4” (i.e. (0+4) mod 8). Further, a second UE may be assigned a cyclic shift value of “001”. Thus, the first index k1 may be “1”, and the second index may be “5” (i.e. (1+4) mod 8) e.g. within the same PHICH group. Alternatively, in case of an extended cyclic prefix length, a first UE may be assigned a cyclic shift value of “000”. Accordingly, the first index k1 may be “0”, and the second index may be “2” (i.e. (0+2) mod 4) e.g. within the same PHICH group. A second UE may be assigned a cyclic shift value of “001”. Thus, the first index k1 may be “1”, and the second index may be “3” (i.e. (1+2) mod 4).

Further, in both of the above alternatives, as shown in FIG. 4, the first and second information channels may be decoupled from cyclic shift resources.

Thus, as shown in FIG. 4, in case of an initial cyclic prefix length, a first UE may be assigned a first index k1 being “0” independently from the cyclic shift value, and the second index may be “4” (i.e. (0+4) mod 8). Further, a second UE may be assigned a first index k1 being “6” independently from the cyclic shift value, and the second index may be “2” (i.e. (6+4) mod 8) e.g. in the same PHICH group. Alternatively, in case of an extended cyclic prefix length, a first UE may be assigned a first index k1 being “0”, and the second index may be “2” (i.e. (0+2) mod 4) e.g. within the same PHICH group. A second UE may be assigned a first index k1 being “3”, and the second index may be “1” (i.e. (3+2) mod 4) e.g. in the same PHICH group.

Furthermore, at least one of, or more of the above-described means for configuring 2015, 2025, means for transmitting 2023 and means for receiving 2014 as well as the UE 201 and the eNB 202, or the respective functionalities carried out, may be implemented as a chipset, module or subassembly.

Finally, the examples of present invention also relate to a system which may comprise the UE 201 and the eNB 202 according to the above-described first and second examples of the present invention.

Without being restricted to the details following in this section, the examples of the present invention may be summarized as follows:

Regarding to DMRS usage with SU-MIMO, there are two general principles achieving orthogonal reference signals between different transmit antennas (or spatial layers)
Use of cyclic shift separation
Use of orthogonal cover codes
   It is anticipated that a certain combination of these schemes will be applied in the case of SU-MIMO.
   The invention may reside in having a mapping rule defined in specifications which defines the default UE and eNB behavior concerning the case of using spatial multiplexing without layer shifting (operating with dual A/N signals for UL data). The mapping rule may target at creating an automatic mapping to PHICH channels which are “preferred pairs” of each other. Such preferred pairs may be constructed such that the dual A/N signals would constitute a QPSK symbol.
   One algorithm for this could be to tie the PHICH channel of the first layer to the PRB index, and then the second PHICH channel is getting an index within the same PHICH group which can be calculated as (for normal cyclic prefix):
k2=((k1+4)mod 8), where k1 is the PHICH index of the first PHICH channel, and k2 is the PHICH channel for the second layer. In this way, each dual-PHICH transmission may become a QPSK symbol.
For extended cyclic prefix, the equation would be k2=((k1+2)mod4), as the number of PHICH channels per PHICH group is less.
   There may also be a special rule in specifications that redefines the PHICH channel index calculations for a second layer in case of SU-MIMO transmission.
   Further, there may be certain rules on how to arrange implicit relationship between the DMRS cyclic shift resources of SU-MIMO and PHICH resources corresponding to a second codeword.
   One design criterion for ACK/NACK signaling on PHICH may be compatibility with optimized MU-MIMO pairing (i.e. co-existence of SU-MIMO, being configured for codeword-specific ACK/NACK signaling in DL, and MU-MIMO) taking into account cross correlation properties between the occupied cyclic shift resources. For backward compatibility reasons, this relationship should be kept also in LTE-Advanced.
   Moreover, one approach may reside in combining the SU-MIMO cyclic shift resources with the PHICH resources, i.e. cyclic shifts corresponding to reserved PHICH resources could be reserved by the second ACK/NACK resource. The principle is presented in FIG. 3, which shows an example of MU-MIMO pairing with two SU-MIMO UEs being configured for codeword-specific ACK/NACK signaling on PHICH.
   Another choice shown in FIG. 4 shows an example where the cyclic shift resources (or more generally DM RS resources) occupied by SU-MIMO UE are decoupled from the PHICH resources reserved by the second ACK/NACK resource. One approach is that both cyclic shift and PHICH resources are defined using separate rules. E.g., cyclic shift resources are defined in such that cross correlation properties between occupied resources are minimized and PHICH performance is being optimized.
   To sum up, there may be two implicit mapping rules for handling the assignment of the resources for SU-MIMO. First implicit rule may be to map towards the PHICH resources using QPSK, while the second rule may handle the implicit mapping of the associated DMRS index.

[Further Examples]

For the purpose of the present invention as described herein above, it should be noted that
an access technology may be any technology by means of which a user equipment can access an access network (or base station, respectively). Any present or future technology, such as WiMAX (Worldwide Interoperability for Microwave Access) or WLAN (Wireless Local Access Network), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed line.
a network may be any device, unit or means by which a station entity or other user equipment may connect to and/or utilize services offered by the access network; such services include, among others, data and/or (audio-) visual communication, data download etc.;
generally, the present invention may be applicable in those network/user equipment environments relying on a data packet based transmission scheme according to which data are transmitted in data packets and which are, for example, based on the Internet Protocol IP. The present invention is, however, not limited thereto, and any other present or future IP or mobile IP (MIP) version, or, more generally, a protocol following similar principles as (M) IPv4/6, is also applicable;
a user equipment may be any device, unit or means by which a system user may experience services from an access network;
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may alternatively be based on any security architecture capable e.g. of authentication, authorization, keying and/or traffic protection;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

According to an example of the present invention, in a first aspect, this object is for example achieved by a method comprising:

configuring N information channels each carrying acknowledgement information such that the N pieces of acknowledgement information are transmittable in the form of a phase shift keying symbol having an order of N², N being an integer equal to or greater than 2.

According to further refinements of the example of the present invention as defined under the above first aspect,
the method further comprises transmitting, on the N information channels, the N pieces of acknowledgement information in the form of the phase shift keying symbol having the order of N².

According to an example of the present invention, in a second aspect, this object is for example achieved by a method comprising:

configuring N information channels each carrying acknowledgement information such that the N pieces of acknowledgement information are receivable in the form of a phase shift keying symbol having an order of N², N being an integer equal to or greater than 2.

According to further refinements of the example of the present invention as defined under the above second aspect,
the method further comprises receiving, on the N information channels, the N pieces of acknowledgement information in the form of the phase shift keying symbol having the order of N².

According to further refinements of the example of the present invention as defined under the above first and second aspects,
each of the N information channels is associated with a respective one of N transport blocks;
N is equal to 2, and the phase shift keying symbol is a quadrature phase shift keying symbol;
in case of usage of a cyclic prefix, the first information channel is assigned a first index k1 based on a physical resource block index, and the second information channel is assigned a second index k2 according to: k2=(k1+4) mod 8;
in case of usage of an extended cyclic prefix, the first information channel is assigned a first index k1 based on a physical resource block index, and the second information channel is assigned a second index k2 according to: k2=(k1+2) mod 4;
the second information channel is associated with cyclic shift resources;
the first and second indices respectively correspond to cyclic shift information associated with the first and second information channels;
the second information channel is decoupled from cyclic shift resources;
the information channels are constituted by physical hybrid automatic repeat request indicator channels;
the physical hybrid automatic repeat request indicator channels have no layer shifting;
the acknowledgement information is constituted by an acknowledgement/non-acknowledgement signal;
the cyclic shift information is constituted by cyclic shift fields in a downlink control information format.

According to an example of the present invention, in a third aspect, this object is for example achieved by an apparatus comprising:

means for configuring N information channels each carrying acknowledgement information such that the N pieces of acknowledgement information are transmittable in the form of a phase shift keying symbol having an order of N², N being an integer equal to or greater than 2.

According to further refinements of the example of the present invention as defined under the above third aspect,
the apparatus further comprises means for transmitting, on the N information channels, the N pieces of acknowledgement information in the form of the phase shift keying symbol having the order of N²;
the apparatus is constituted by an evolved node B.

According to an example of the present invention, in a fourth aspect, this object is for example achieved by an apparatus comprising:

means for configuring N information channels each carrying acknowledgement information such that the N pieces of acknowledgement information are receivable in the form of a phase shift keying symbol having an order of N², N being an integer equal to or greater than 2.

According to further refinements of the example of the present invention as defined under the above fourth aspect,
the apparatus further comprises means for receiving, on the N information channels, the N pieces of acknowledgement information in the form of the phase shift keying symbol having the order of N²;
the apparatus is constituted by one of a user equipment and a user terminal.

According to further refinements of the example of the present invention as defined under the above third and fourth aspects,
each of the N information channels is associated with a respective one of N transport blocks;
N is equal to 2, and the phase shift keying symbol is a quadrature phase shift keying symbol;
in case of usage of a cyclic prefix, the first information channel is assigned a first index k1 based on a physical resource block index, and the second information channel is assigned a second index k2 according to: k2=(k1+4) mod 8;
in case of usage of an extended cyclic prefix, the first information channel is assigned a first index k1 based on a physical resource block index, and the second information channel is assigned a second index k2 according to: k2=(k1+2) mod 4;
the second information channel is associated with cyclic shift resources;
the first and second indices respectively correspond to cyclic shift information associated with the first and second information channels;
the second information channel is decoupled from cyclic shift resources;
the information channels are constituted by physical hybrid automatic repeat request indicator channels;
the physical hybrid automatic repeat request indicator channels have no layer shifting;
the acknowledgement information is constituted by an acknowledgement/non-acknowledgement signal;
the cyclic shift information is constituted by cyclic shift fields in a downlink control information format;
at least one, or more of means for configuring, means for transmitting, means for receiving and the apparatus is implemented as a chipset, module or subassembly.

According to an example of the present invention, in a fifth aspect, this object is for example achieved by an apparatus comprising:

a configurator configured to configure N information channels each carrying acknowledgement information such that the N pieces of acknowledgement information are transmittable in the form of a phase shift keying symbol having an order of N², N being an integer equal to or greater than 2.

According to further refinements of the example of the present invention as defined under the above fifth aspect,
the apparatus further comprises a transmitter configured to transmit, on the N information channels, the N pieces of acknowledgement information in the form of the phase shift keying symbol having the order of N²;
the apparatus is constituted by an evolved node B.

According to an example of the present invention, in a sixth aspect, this object is for example achieved by an apparatus comprising:

a configurator configured to configure N information channels each carrying acknowledgement information such that the N pieces of acknowledgement information are receivable in the form of a phase shift keying symbol having an order of N², N being an integer equal to or greater than 2.

According to further refinements of the example of the present invention as defined under the above sixth aspect,
the apparatus further comprises a receiver configured to receive, on the N information channels, the N pieces of acknowledgement information in the form of the phase shift keying symbol having the order of N²;
the apparatus is constituted by one of a user equipment and a user terminal.

According to further refinements of the example of the present invention as defined under the above fifth and sixth aspects,
each of the N information channels is associated with a respective one of N transport blocks;
N is equal to 2, and the phase shift keying symbol is a quadrature phase shift keying symbol;
in case of usage of a cyclic prefix, the first information channel is assigned a first index k1 based on a physical resource block index, and the second information channel is assigned a second index k2 according to: k2=(k1+4) mod 8;
in case of usage of an extended cyclic prefix, the first information channel is assigned a first index k1 based on a physical resource block index, and the second information channel is assigned a second index k2 according to: k2=(k1+2) mod 4;
the second information channel is associated with cyclic shift resources;
the first and second indices respectively correspond to cyclic shift information associated with the first and second information channels;
the second information channel is decoupled from cyclic shift resources;
the information channels are constituted by physical hybrid automatic repeat request indicator channels;
the physical hybrid automatic repeat request indicator channels have no layer shifting;
the acknowledgement information is constituted by an acknowledgement/non-acknowledgement signal;
the cyclic shift information is constituted by cyclic shift fields in a downlink control information format;
at least one, or more of a configurator, a transmitter, a receiver and the apparatus is implemented as a chipset, module or subassembly.

According to an example of the present invention, in a seventh aspect, this object is for example achieved by a system comprising:

an apparatus according to the above third or fifth aspect, and

an apparatus according to the above fourth or sixth aspect.

According to an example of the present invention, in an eighth aspect, this object is for example achieved by a computer program product comprising code means for performing a method according to the above first and second aspects when run on a processing means or module.

According to an example of the present invention, in a ninth aspect, this object is for example achieved by a computer program comprising code means for performing, when executed on a processor:

configuring N information channels each carrying acknowledgement information such that the N pieces of acknowledgement information are transmittable in the form of a phase shift keying symbol having an order of N², N being an integer equal to or greater than 2.

According to an example of the present invention, in a tenth aspect, this object is for example achieved by a computer program comprising code means for performing, when executed on a processor:

configuring N information channels each carrying acknowledgement information such that the N pieces of acknowledgement information are receivable in the form of a phase shift keying symbol having an order of N², N being an integer equal to or greater than 2.

Although the present invention has been described herein before with reference to particular embodiments thereof, the present invention is not limited thereto and various modifications can be made thereto.

1. A method, comprising: configuring N information channels each carrying acknowledgement information such that the N pieces of acknowledgement information are transmittable in the form of a phase shift keying symbol having an order of N², N being an integer equal to or greater than 2.

2. The method according to claim 1, further comprising transmitting, on the N information channels, the N pieces of acknowledgement information in the form of the phase shift keying symbol having the order of N².

3. A method, comprising: configuring N information channels each carrying acknowledgement information such that the N pieces of acknowledgement information are receivable in the form of a phase shift keying symbol having an order of N², N being an integer equal to or greater than 2.

4. The method according to claim 3, further comprising receiving, on the N information channels, the N pieces of acknowledgement information in the form of the phase shift keying symbol having the order of N².

5. The method according to claim 1, wherein each of the N information channels is associated with a respective one of N transport blocks.

6. The method according to claim 1, wherein N is equal to 2, and the phase shift keying symbol is a quadrature phase shift keying symbol.

7. The method according to claim 6, wherein, in case of usage of a cyclic prefix, the first information channel is assigned a first index k1 based on a physical resource block index, and the second information channel is assigned a second index k2 according to: k2=(k1+4) mod 8.

8. The method according to claim 6, wherein, in case of usage of an extended cyclic prefix, the first information channel is assigned a first index k1 based on a physical resource block index, and the second information channel is assigned a second index k2 according to: k2=(k1+2) mod 4.

9. The method according to claim 7, wherein the second information channel is associated with cyclic shift resources.

10. The method according to claim 9, wherein the first and second indices respectively correspond to cyclic shift information associated with the first and second information channels.

11. The method according to claim 7, wherein the second information channel is decoupled from cyclic shift resources

12. The method according to claim 1, wherein at least one of the following applies: the information channels are constituted by physical hybrid automatic repeat request indicator channels ; the physical hybrid automatic repeat request indicator channels have no layer shifting;
the acknowledgement information is constituted by an acknowledgement/non-acknowledgement signal; and the cyclic shift information is constituted by cyclic shift fields in a downlink control information format.

13. An apparatus, comprising: means for configuring N information channels each carrying acknowledgement information such that the N pieces of acknowledgement information are transmittable in the form of a phase shift keying symbol having an order of N², N being an integer equal to or greater than 2.

14. The apparatus according to claim 13, further comprising means for transmitting, on the N information channels, the N pieces of acknowledgement information in the form of the phase shift keying symbol having the order of N².

15. An apparatus, comprising: means for configuring N information channels each carrying acknowledgement information such that the N pieces of acknowledgement information are receivable in the form of a phase shift keying symbol having an order of N², N being an integer equal to or greater than 2.

16. The apparatus according to claim 15, further comprising means for receiving, on the N information channels, the N pieces of acknowledgement information in the form of the phase shift keying symbol having the order of N².

17. The apparatus according to claim 13, wherein each of the N information channels is associated with a respective one of N transport blocks.

18. The apparatus according to claim 13, wherein N is equal to 2, and the phase shift keying symbol is a quadrature phase shift keying symbol.

19. The apparatus according to claim 18, wherein, in case of usage of a cyclic prefix, the first information channel is assigned a first index k1 based on a physical resource block index, and the second information channel is assigned a second index k2 according to: k2=(k1+4) mod 8.

20. The apparatus according to claim 18, wherein, in case of usage of an extended cyclic prefix, the first information channel is assigned a first index k1 based on a physical resource block index, and the second information channel is assigned a second index k2 according to: k2=(k1+2) mod 4.

21. The apparatus according to claim 19, wherein the second information channel is associated with cyclic shift resources.

22. The apparatus according to claim 21, wherein the first and second indices respectively correspond to cyclic shift information associated with the first and second information channels.

23. The apparatus according to claim 19, wherein the second information channel is decoupled from cyclic shift resources.

24. The apparatus according to any one of claims 13 to 23 claim 13, wherein at least one of the following applies: the information channels are constituted by physical hybrid automatic repeat request indicator channels; the physical hybrid automatic repeat request indicator channels have no layer shifting; the acknowledgement information is constituted by an acknowledgement/non-acknowledgement signal; and the cyclic shift information is constituted by cyclic shift fields in a downlink control information format .

25. The apparatus according to claim 14, wherein the apparatus is constituted by an evolved node B.

26. The apparatus according to claim 16 wherein the apparatus is constituted by one of a user equipment and a user terminal.

27. The apparatus according to claim 13 , wherein at least one, or more of means for configuring, means for transmitting, means for receiving and the apparatus is implemented as a chipset, module or subassembly.

28. A computer program product comprising code means for performing a method according to claim 1 when run on a processing means or module.
